(19) United States
(12) Patent Application Publication
(10) Pub. No.: US 2007/0088549 A1
(43) Pub. Date: Apr. 19, 2007

(54) Natural input of arbitrary text

(75) Inventor: David Mowatt, Seattle, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/251,250

(22) Filed: Oct. 14, 2005

(51) Int. Cl. G10L 15/06

(52) U.S. Cl. 704/243

(57) ABSTRACT

A method and system for enabling a speech recognition system to recognize entities having arbitrary text. The method includes identifying an entity having arbitrary text from a user and detecting that the entity has an identifiable pattern of characters. The speech recognition system prompts the user to assign an alternative natural phrase that corresponds with the entity. The alternative natural phrase is stored in a dictionary to thereby textually enter the entity upon capturing the corresponding natural phrase.

### BACKGROUND

An alias is a string of characters, such as letters, numbers and/or symbols, which comprise an alternate name of a user. An email alias is an email address of a user that includes an alias, followed by an “@” symbol and further followed by a domain name. Commonly, an email alias is referred to as a simple mail transfer protocol (SMTP) alias that is used for interacting with a computer network and sending textual messages between servers of a computer network.

Email aliases were designed to be entered into a computing device using a keyboard. Email aliases were never intended to be spoken in the natural language. Speech recognition systems were designed to transcribe voice into text using a pronunciation dictionary that spells out textual representations into phonemes. However, accuracy of speech recognition systems degenerate quickly when an entity or unit of text is not a standard “word”. For example, if a spoken entity includes arbitrary text, such as an email alias, the speech recognition system has difficulty recognizing the entity and will, therefore, transcribe gibberish.

Many speech recognition systems can accommodate out of dictionary vocabulary, such as acronyms and jargon, using a letter-to-sound (LTS) subsystem. Current LTS subsystems are designed to map orthography into phonemes. However, the phonetic pronunciation of an alias is unnatural and confusing. Also, in many cases, an LTS subsystem will guess a pronunciation incorrectly.

Many speech recognition systems allow users to correct misrecognitions or gibberish. For example, speech recognition systems allow a user to select incorrect text for correction and alter the spelling of the incorrect text letter by letter. While these ftunctionalities allow users to enter entities having arbitrary text, these processes are time consuming, painful and unnatural.

The discussion above is merely provided for general background information and is not intended to be used as an aid in determining the scope of the claimed subject matter.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Enabling a speech recognition system to recognize entities having arbitrary text and entering entities having arbitrary text using a speech recognition system allows for the natural input of arbitrary text using voice. A speech recognition system identifies an entity having arbitrary text. The speech recognition system then detects that the entity having arbitrary text has an identifiable pattern of characters and in turn prompts the user to assign an alternative natural phrase that corresponds with the entity having arbitrary text. Upon capturing the alternative natural phrase, the speech recognition system retrieves and textually enters the corresponding entity having arbitrary text.

### BRIEF DESCRIPTION OF THE DRAWINGS

FIG. 1 is a simplified block diagram of one computing environment in which some embodiments may be practiced.

FIG. 2 is a simplified block diagram of another computing environment in which some embodiments may be practiced.

FIG. 3 illustrates a simplified block diagram of a speech recognition system in which embodiments are used.

FIG. 4 is a flowchart illustrating computer-implemented steps of enabling a speech recognition system to recognize specific entities having arbitrary text.

FIGS. 5-10 illustrate example screenshots showing a speech recognition system performing the steps illustrated in FIG. 4.

FIG. 11 is a flowchart illustrating computer-implemented steps of entering entities having arbitrary text using a speech recognition system.

FIGS. 12-15 illustrate example screenshots showing a speech recognition system performing the steps illustrated in FIG. 11.

FIG. 16 illustrates an example screenshot showing a speech correction subsystem correcting a transcription.

FIGS. 17-18 illustrate example screenshots showing a speech recognition engine reassigning alternative natural phrases to entities having arbitrary text.

### DETAILED DESCRIPTION

The following description is described in the context of an automated speech recognition system for recognizing entities that include arbitrary text. An entity is a unit of text that is a string of characters (i.e. letters, numbers and/or symbols) that can be continuous and uninterrupted or can be separated by spaces. Example entities that include arbitrary text include email aliases and uniform resource locators (URLs). An email alias is an email address associated with an individual. The email alias includes an alias or uniform resource identifier (URI), followed by an “@” symbol, which is followed by a domain name. A URI comprises an alternate name of a user or individual. URIs generally or frequently contain at least portions of a first name, middle name, last name and/or organization name. However, URI's can also contain arbitrary names or words. A domain name generally or frequently contains at least one period that is followed by a top-level domain, such as com, net, org, and etc. The beginning of a URL generally or frequently contains a “www” or “http” at the beginning. Entities that include arbitrary text are not limited to email aliases and URLs. The following description is described in the context of other types of entities that include arbitrary text. For example, inventory identifiers or serial identifiers for referring to various manufacturing parts or commercial products are also example entities that include arbitrary text.

Example implementations for such a system include computing devices such as desktops or mobile devices. Example mobile devices include personal data assistants (PDAs), landline phones and cellular phones. In particular, the system can be implemented using PDAs, landline phones and cellular phones having text messaging capabilities. This list of computing devices is not an exhaustive list. Other types of devices are contemplated by the present invention. Prior to describing the present invention in detail, embodiments of illustrative computing environments within which the present invention can be applied will be described.

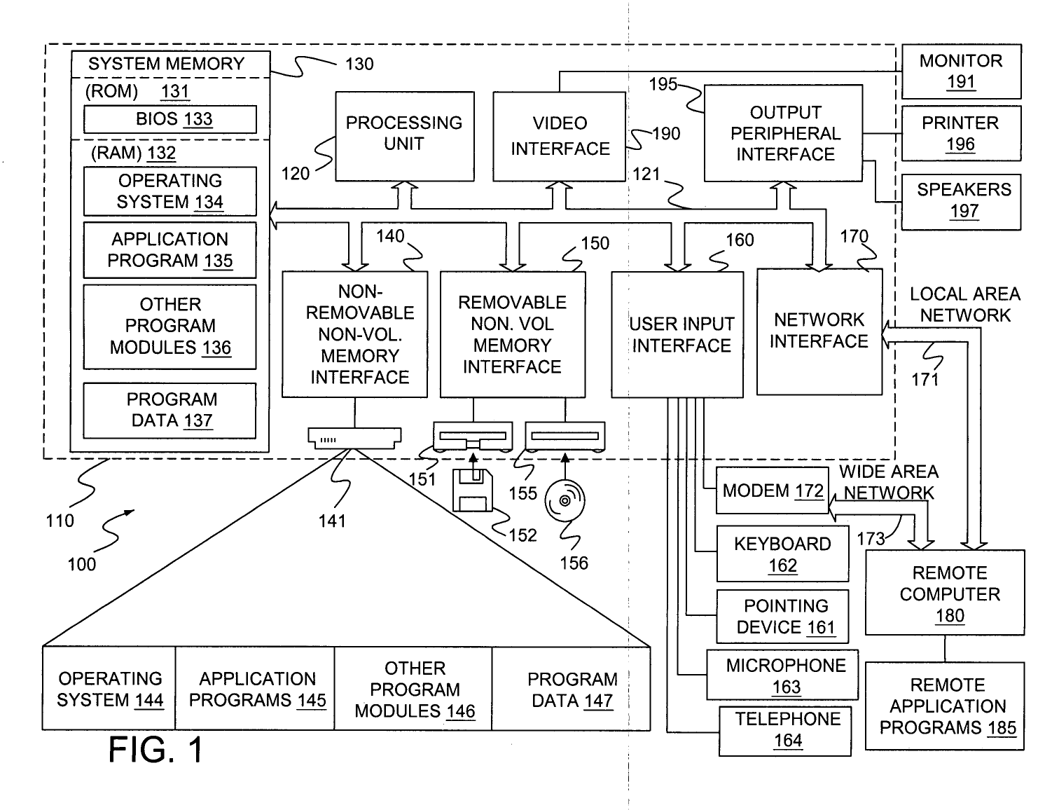

FIG. 1 illustrates an example of a suitable computing system environment 100 on which embodiments may be implemented. The computing system environment 100 is only one example of a suitable computing environment and is not intended to suggest any limitation as to the scope of use or functionality of various embodiments. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, a pointing device 161, such as a mouse, trackball or touch pad and a telephone 164. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

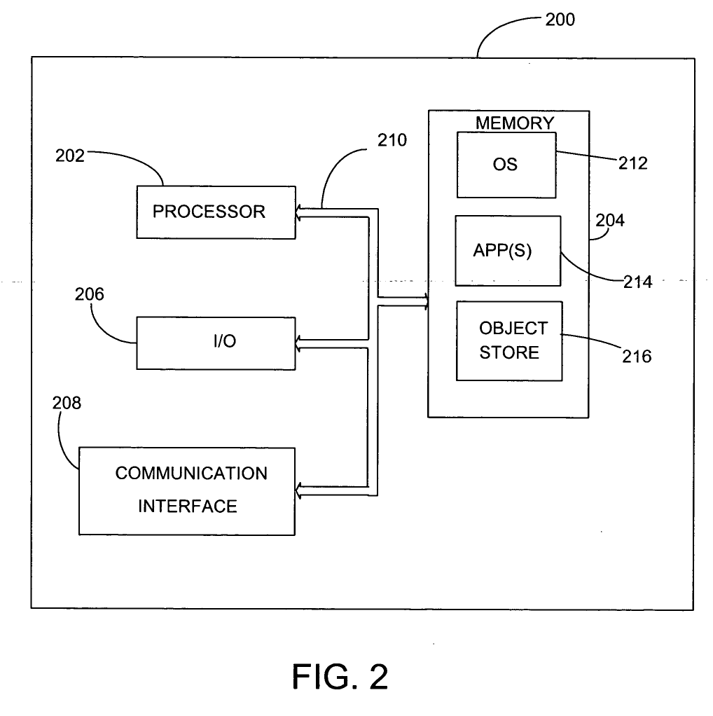

FIG. 2 is a block diagram of an example mobile device 200, which is another applicable computing environment. Mobile device 200 includes a microprocessor 202, memory 204, input/output (I/O) components 206, and a communication interface 208 for communicating with remote computers or other mobile devices. In one embodiment, the aforementioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200 within the scope of the present invention.

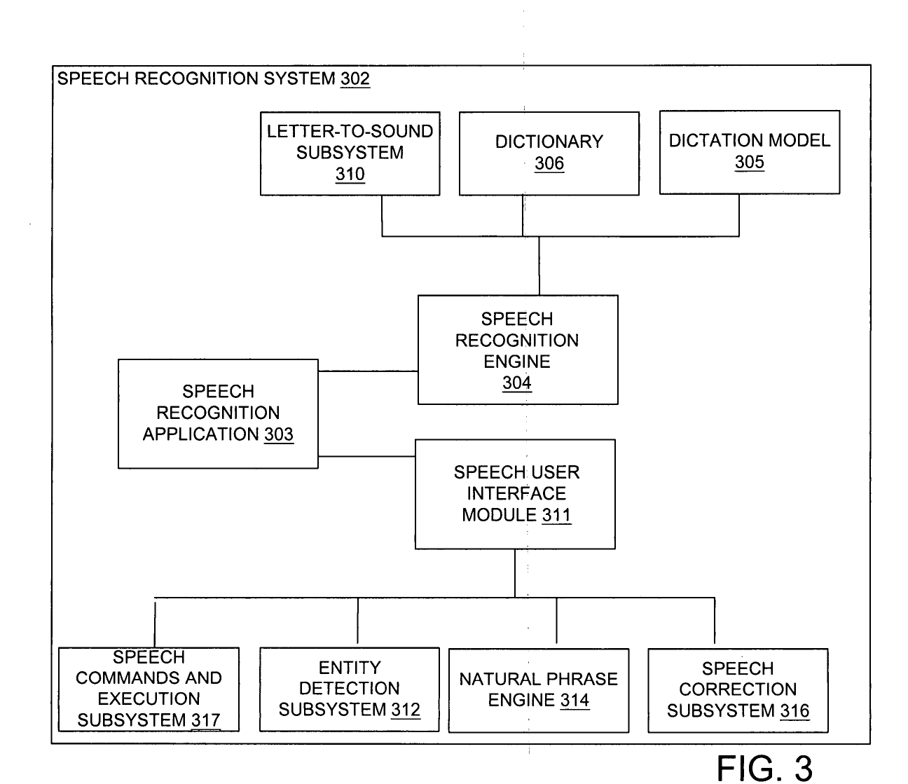

FIG. 3 illustrates a speech recognition system 302 for recognizing spoken entities. Speech recognition system 302 can be incorporated into any of the above-described computing devices. Speech recognition system 302 includes two core components: a speech recognition engine module 304 and a speech user interface module 311. In one embodiment, a speech recognition application 303 ties the functionality of the two modules 304 and 311 together. In other embodiments, speech recognition engine module 304 and speech user interface module 311 work closely together without the need of speech recognition application 303. Speech recognition system 302 also a utilizes a dictation model 305, a dictionary 306 and a letter-to-sound subsystem 310 to transcribe voice into text. Dictation model 305 contains information about which words generally appear next to each other. Dictionary 306 holds a list of terms and associated pronunciations that are recognized by speech recognition engine 304. Letter-to-sound (LTS) subsystem 310 contains a set of letter-to-sound rules for converting letters to sounds and sounds to letters. LTS subsystem 310 accounts for words that are not in dictionary 306. The set of letter-to-sound rules are determined by using a machine learning technique to deduce rules from an external dictionary or database. Information from dictation model 305, dictionary 306 and letter-to-sound subsystem 310 are combined to enable system 302 to correctly recognize speech, such as “I said today” instead of “eyes hate Ode A”. Speech user interface module 311 utilizes a speech commands and execution subsystem 317. Speech commands and execution subsystem 317 controls the list of voice commands and dictation that the user can speak at any given moment and takes action upon recognition. For example, speech commands and execution subsystem 317 can enter the text the user spoke.

Entities that have arbitrary text can be specific to the user. For example, arbitrary text can be personal email addresses and websites that the user navigates to. In general, system 302 will not have these list of email addresses or websites installed in its dictionary. In addition, LTS subsystem 310 is configured to map orthography (of common words) to phonemes. Therefore, LTS subsystem 310 can not accurately recognize a naturally spoken entity having arbitrary text. To enable speech recognition system 302 to recognize and enter entities that have arbitrary text, speech recognition system 302 includes an entity detection subsystem 312, a natural phrase engine 314 and a speech correction subsystem 316. The following is a description of a computer-implemented method for enabling speech recognition system 302 to recognize specific entities that include arbitrary text as well as a description of a computer-implemented method for entering entities having arbitrary text using the speech recognition system. Both methods use the various components of speech recognition system 302.

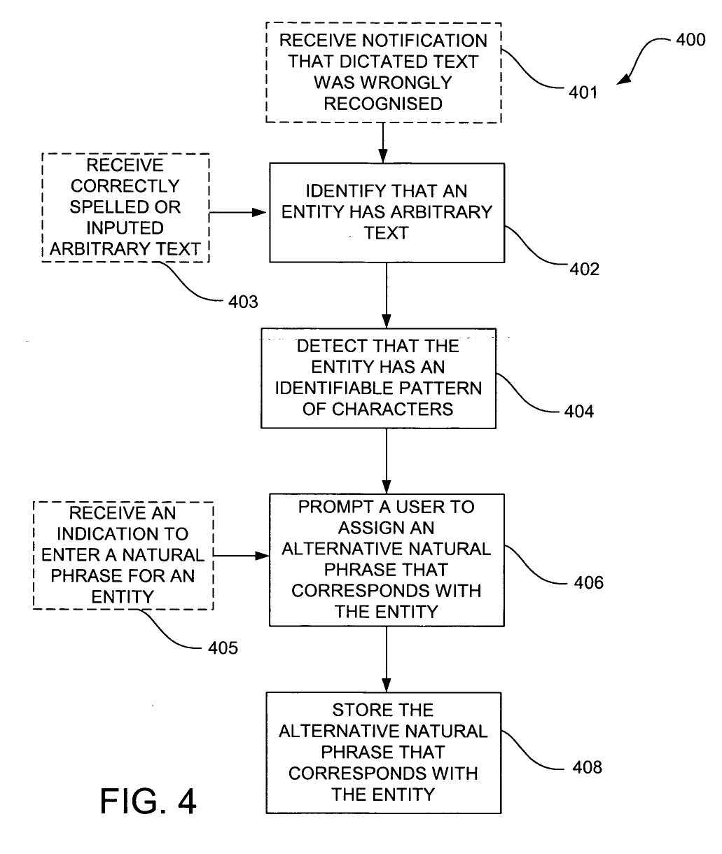

FIG. 4 is a flowchart 400 illustrating steps to enable speech recognition system 302 (FIG. 3) to recognize an entity that has arbitrary text. At block 402, speech recognition engine 304 (FIG. 3) is configured to identify that an entity arbitrary text. In one aspect, speech recognition engine 304 identifies that an entity has arbitrary text after the engine receives an indication from the user that the most recently dictated text was wrongly recognized (as illustrated in block 401). In another aspect, a user might know ahead of time that the arbitrary text that they want to dictate cannot be recognized by system 302. Therefore, speech recognition engine 304 identifies that that an entity has arbitrary text after the engine receives from the user a correctly spelled or manually entered entity (as illustrated in block 403). At block 404, entity detection subsystem 312 (FIG. 3) is configured to detect that the identified entity has an identifiable pattern of characters. In one example, to identify an email alias entity detection subsystem 312 can parse the string of characters and determine that the entity includes a certain type of character, such as an “@” symbol and at least one period. To identify a URL, entity detection subsystem 312 can parse the string of characters and determine that the entity includes a certain types of characters, such as “www” or “http”. Similar techniques for detecting that a string of characters having arbitrary text have an identifiable pattern of characters can be utilized to detect other types of entities that have arbitrary text. For example, if the entity having arbitrary text is an inventory serial number having a combination of letters and numbers, entity detection system 312 can determine that the entity contains a certain number of letters and numbers and therefore is an inventory serial number. In another embodiment, entity detection subsystem 312 detects that an entity having arbitrary text has an identifiable pattern of characters using statistical techniques. For example, if the arbitrary text is a Latin plant term, such as “Narcissus Asteoporisagus” instead of a more common term, a statistical method can be successfully employed to detect that the Latin term is arbitrary text.

In some instances, a user knows that speech recognition system 302 has the ability to substitute natural pronunciations for arbitrary text without the speech recognition system identifying that an entity has arbitrary text and detecting that the entity has an identifiable pattern of characters. In this instance, speech recognition system 302 is able to receive an indication that a user would like to enter a natural phrase for an entity as optionally illustrated at block 405. Therefore, the method illustrated in FIG. 3 can either begin at block 405 or at block 402. Regardless of the beginning point of the method illustrated in FIG. 3, at block 406, natural phrase engine 314 (FIG. 3) is configured to prompt a user to assign an alternative natural phrase that corresponds with the entity having arbitrary text. At block 408, dictionary 306 (FIG. 3) is configured to store the alternative natural phrase that corresponds with the entity having arbitrary text. After dictionary 306 stores the alternative natural phrase that corresponds with the entity having arbitrary text, the user is free to speak the natural phrase to enter the arbitrary text.

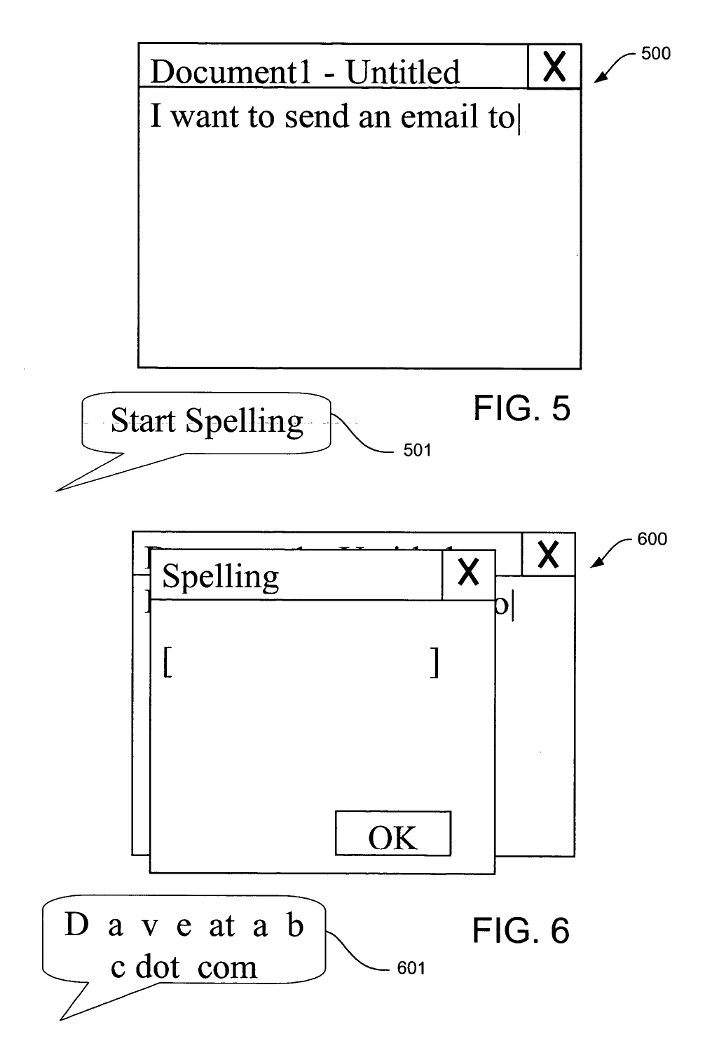

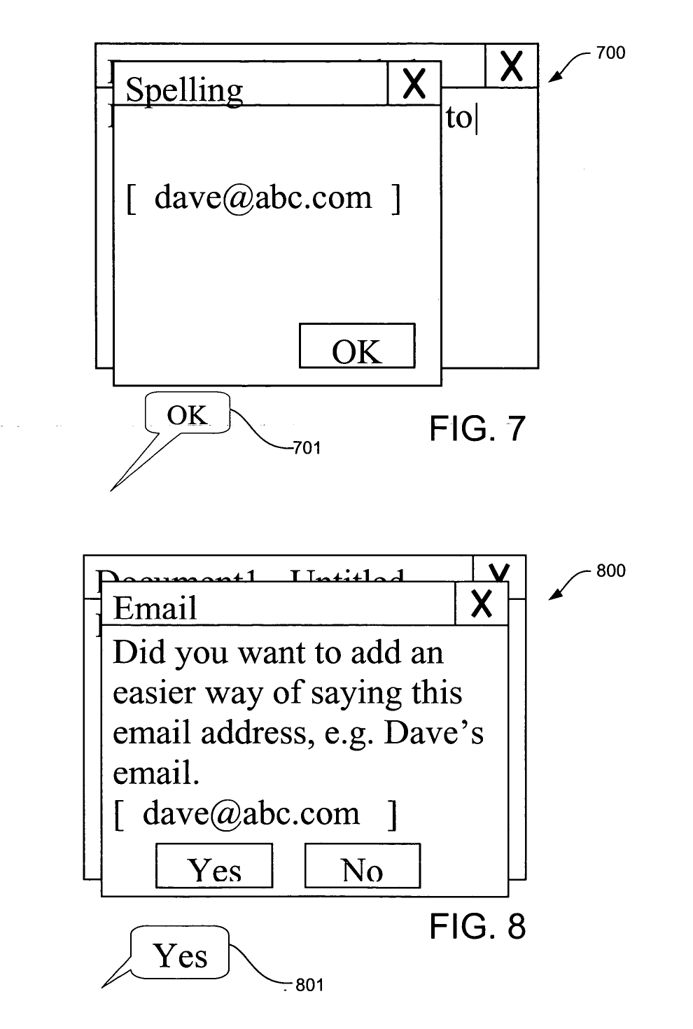

FIGS. 5-10 illustrate example screenshots showing speech recognition system 302 (FIG. 3) performing the steps illustrated in FIG. 4. In FIG. 5, screenshot 500 illustrates that a user has dictated and entered the phrase “I want to send an email to” using speech recognition system 302 into a word processing document. At this point, the user would like to dictate and enter an email alias. Acknowledging that speech recognition system 302 is unable to transcribe a naturally spoken email alias because it is an entity that includes arbitrary text, the user has informed speech recognition system 302 that the next source of dictation will be spelled out by the user by instructing the system to “start spelling” as illustrated in block 501. In FIG. 6, screenshot 600 illustrates the user spelling out the email alias by dictating “d” “a” “e” “at” “a” “b” “c” “dot” “com” as illustrated in block 601. This step can be found in block 403 of FIG. 3. In FIG. 7, screenshot 700 illustrates that the email alias has been correctly spelled by speech recognition system 302 and the user dictates “ok” as illustrated in block 701 to return speech recognition system 302 to normal speech recognition capture. However, instead of returning to normal dictation, entity detection subsystem 312 (FIG. 3) detects that the spelled entity has an identifiable pattern of characters. In this case, the identifiable pattern of characters is an email alias. Entity detection subsystem 312 is able to detect that the spelled entity is an email alias having arbitrary text by parsing and determining that the entity contains one @ sign and at least one period.

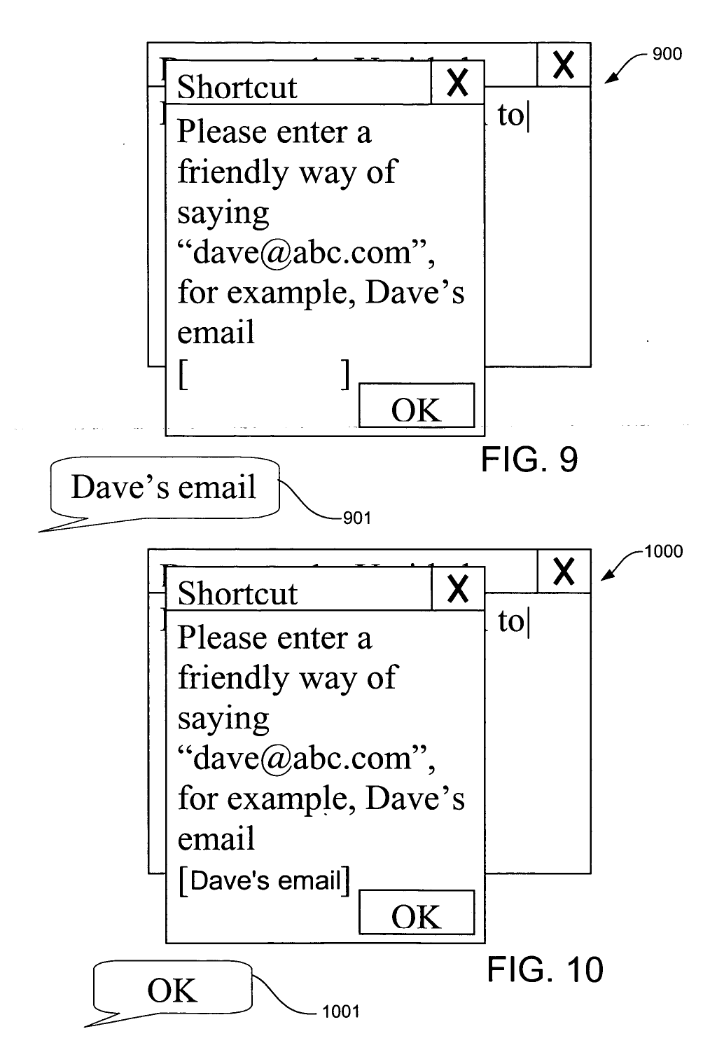

After entity detection subsystem 312 detects that the entity is an email alias, speech recognition system 302 displays screenshot 800 illustrated in FIG. 8. Natural phrase engine 314 (FIG. 3) is configured to prompt a user to assign an alternative natural phrase that corresponds with the entity having arbitrary text. The alternative natural phrase for an entity is generally a friendlier or easier way for the user to refer to an email alias or other type of entity having arbitrary text. In screenshot 800, natural phrase engine 314 asks that the user indicate whether they would like to assign an alternative natural phrase and also suggests at least one alternative natural phrase that can be used. As indicated in FIG. 8, the suggested alternative natural phrase is “Dave's email”. The user decides to assign an alternative phrase and dictates “Yes” as illustrated in block 801. In FIG. 9, the user dictates the alternative natural phrase “Dave's email” as illustrated in block 901. In FIG. 10, screenshot 1000 indicates the transcription of the user's alternative natural phrase. The user continues by dictating “OK” as illustrated in block 1001. By dictating “OK”, the alternative natural phrase is stored in dictionary 306 and is tied to the corresponding entity having arbitrary text. Therefore, speech recognition system 302 is enabled to receive a dictated alternative natural phrase, such as “Dave's email”, for a specific email alias and able to access and enter the email alias after capturing of the corresponding alternative natural phrase. Although the example illustrated in FIGS. 5-10 enables speech recognition system 302 to recognize an email alias, it should be understood that the example screenshots can be modified to be used in connection with enabling the speech recognition system to recognize a specific URL, inventory serial number and other types of entities that have arbitrary text.

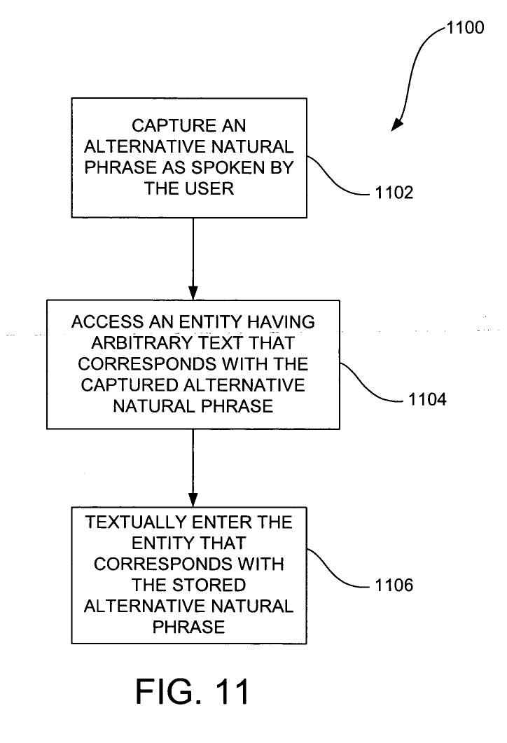

FIG. 11 is a flowchart illustrating steps for entering an entity having arbitrary text using speech recognition system 302 (FIG. 3). At block 1102, speech recognition system 302 captures an alternative natural phrase as spoken by a user. At block 1104, speech recognition system 302 accesses an entity having arbitrary text from dictionary 306 (FIG. 3) that corresponds with the captured alternative natural phrase. At block 406, speech recognition system 302 textually enters the entity that corresponds with the alternative natural phrase stored in dictionary 306.

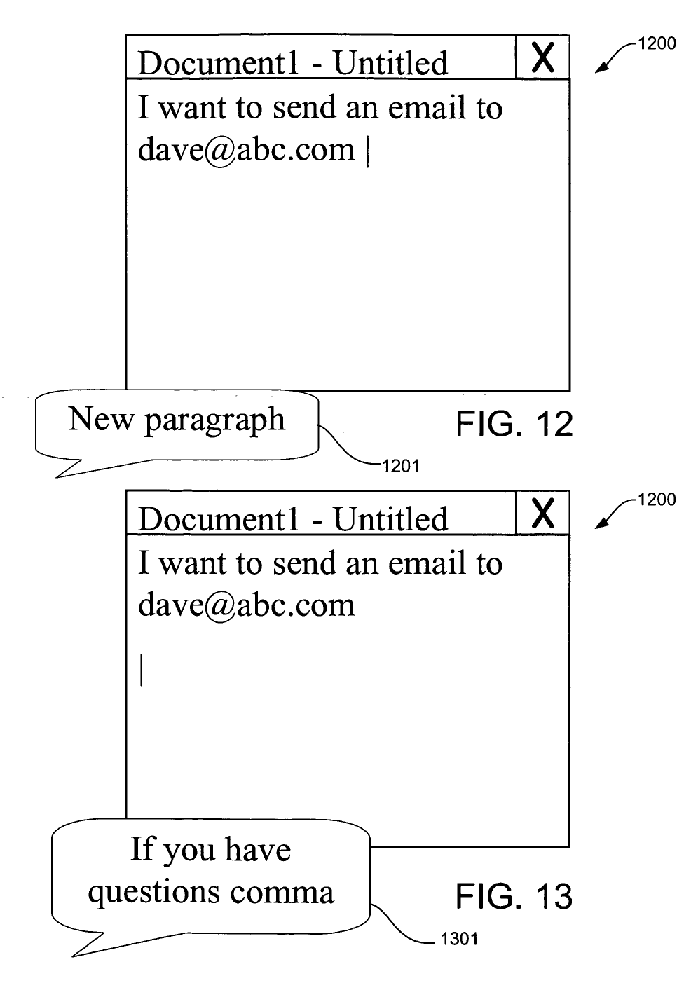

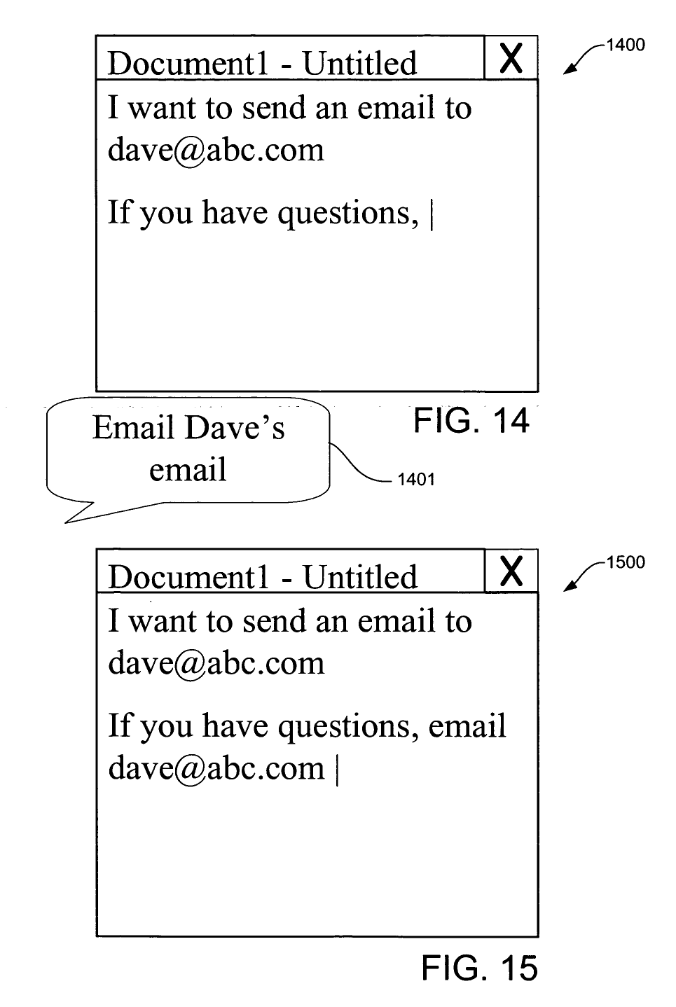

FIGS. 12-16 illustrate example screenshots showing speech recognition system 302 (FIG. 3) performing the steps illustrated in FIG. 11. In FIG. 12, screenshot 1200 illustrates that the user returns to the document in which the user was dictating and entering text as previously discussed with respect to FIGS. 5-7. At block 1201, the user instructs speech recognition system 302 to begin a new paragraph. In FIG. 13, the user dictates “If you have a question comma” as illustrated in block 1301 while simultaneously viewing screenshot 1200. In FIG. 14, screen shot 1400 displays the transcribed dictation spoken in FIG. 13. The user continues by dictating “email Dave's email” as illustrated in block 1401. In accordance with one embodiment, the alternative natural phrase “Dave's email” corresponds with an entity having arbitrary text. Speech recognition system 302 captures the alternative natural phrase spoken by the user, accesses the entity having arbitrary text that corresponds with the captured alternative natural phrase from dictionary 306 and textually enters the entity that corresponds with the alternative natural phrase as illustrated in screenshot 1500 of FIG. 15. Screenshot 1500 displays the transcribed dictation and replaces the user dictated alternative natural phrase “Dave's email” with the proper corresponding email alias. Although the example illustrated in FIGS. 12-15 illustrates the entering of an email alias using speech recognition system 302, it should be understood that the example screenshots can be modified to be used in connection with entering a specific URL, inventory serial number and other types of entities having arbitrary text.

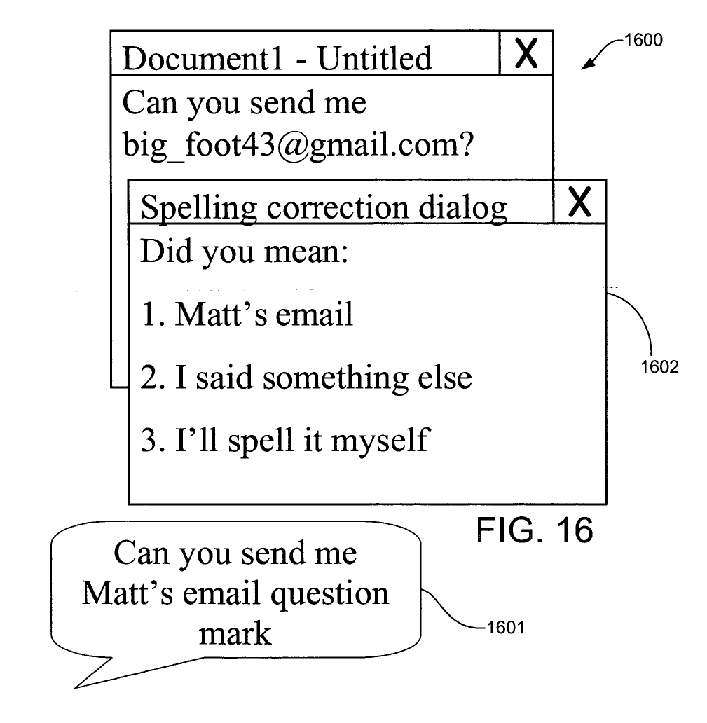

In accordance with another embodiment, speech recognition system 302 (FIG. 3) also includes speech correction subsystem 316 (FIG. 3). Speech recognition subsystem 316 provides, for example, a speech correction dialog 1602 as illustrated in screenshot 1600 of FIG. 16. In FIG. 16, the user has dictated “Can you send me Matt's email question mark” as illustrated in box 1601. Such a dictation has resulted in the entered text shown in the word processing document illustrated in screenshot 1600. In this example, the phrase “Matt's email” is an alternative natural phrase that corresponds with the email alias “big_foot43@gmail.com” that is stored in dictionary 306 (FIG. 3). Therefore, speech recognition system 302 has textually entered the email alias that corresponds with the alternative natural phrase. However, in this example, the user had intended that speech recognition system 302 textually enter the dictated phrase “Matt's email” and not textually enter the corresponding email alias. Speech correction subsystem 316 is configured to visually render a list of alternative interpretations of the captured alternative natural phrase after the entity is textually entered. For example, the visually rendered list of alternative interpretations can be located in speech correction dialog 1602. In the example illustrated in FIG. 16, speech correction dialog 1602 visually renders a single alternative interpretation and two other options for correcting the transcription of speech recognition system 302. However, speech correction subsystem 316 can visually render any number of alternative interpretations and any number of other options. In accordance with the example illustrated in FIG. 16, speech recognition system 302 is configured to replace the textually entered entity (in this case big_foot43@gmail.com) with a selected one of the list of visually rendered alternative interpretations. The user will select the first option (i.e. Matt's email) in spelling correction dialog 1602 for replacement such that the document will coincide with the user's intended sentence.

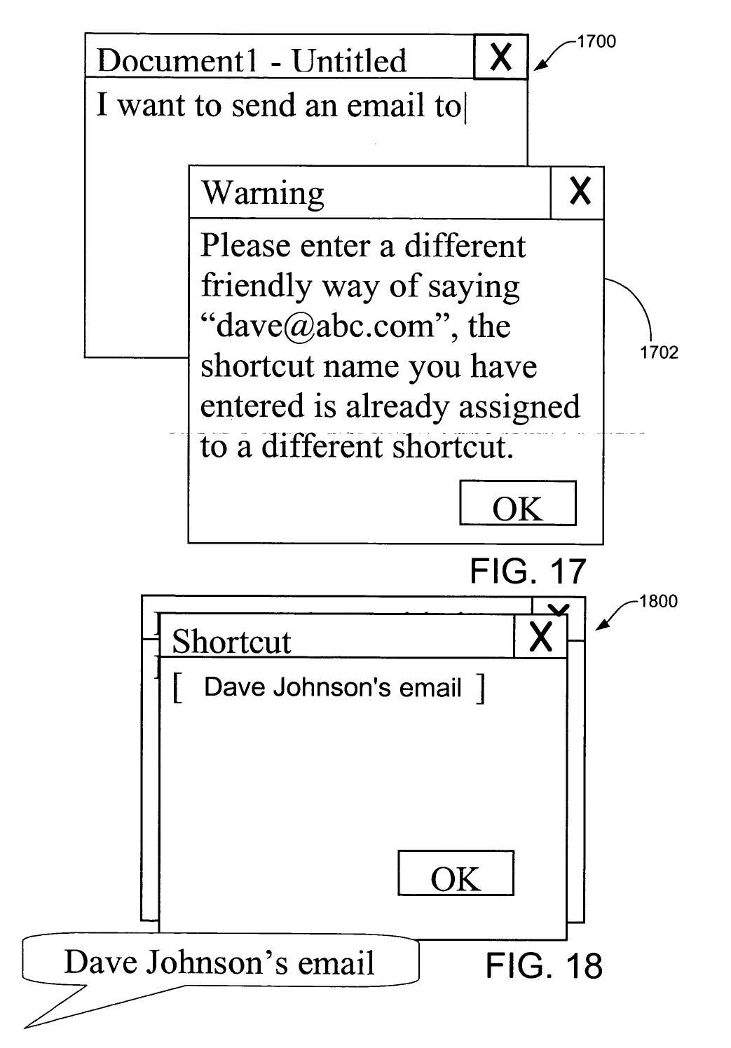

In accordance with yet another embodiment, speech recognition engine 304 of speech recognition system 302 is configured to detect the instance when an alternative natural phrase is being assigned to an entity having arbitrary text that is already assigned to a different entity having arbitrary text. Speech recognition system 302 will prompt the user to reassign a different alternative natural phrase to the entity having arbitrary text. For example, FIG. 17 illustrates screenshot 1700 including a warning dialog 1702 prompting the user to enter a different alternative natural phrase shortcut than “Dave's email” for “dave@abc.com”. As illustrated in screenshot 1800 of FIG. 18, the user can reenter an alternative natural phrase as “Dave Johnson's email”. In addition, speech recognition engine 304 is also configured to prompt the user to reassign a different alternative natural phrase to the different entity. For example, if an email alias was assigned with the same alternative natural phrase as a second email alias, speech recognition engine 304 prompts the user to reassign an alternative natural phrase to the email alias. In the example illustrated in FIGS. 17 and 18, the user reassigns the alternative natural phrase “Dave Johnson's email” to the email alias. The speech recognition engine 304 is also configured to prompt the user to reassign an alternative natural phrase to the second email alias. For example, the user can reassign the alternative natural phrase “Dave Anderson's email” to the second email alias.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of enabling a speech recognition system to recognize entities that have arbitrary text, the method comprising:
identifying an entity having arbitrary text;
detecting that the entity has an identifiable pattern of characters;
prompting a user to assign an alternative natural phrase that corresponds with the entity; and
storing the alternative natural phrase that corresponds with the entity to thereby textually enter the entity upon later capturing of the corresponding alternative natural phrase.

2. The computer-implemented method of claim 1, wherein detecting that the entity has an identifiable pattern of characters comprises parsing and determining that the entity has a pattern of characters that coincide with characters used in an email alias.

3. The computer-implemented method of claim 1, wherein detecting that the entity has an identifiable pattern of characters comprises detecting that the entity has a statistically identifiable pattern of characters.

4. The computer-implemented method of claim 1, further comprising receiving notification from the user that dictated text was wrongly recognized prior to identifying that the entity has arbitrary text.

5. The computer-implemented method of claim 1, further comprising receiving an entity that is spelled by the user prior to identifying that the entity has arbitrary text.

6. The computer-implemented method of claim 1, wherein prompting the user to assign an alternative natural phrase that corresponds with the entity comprises suggesting at least one alternative natural phrase for the entity.

7. The computer-implemented method of claim 1, further comprising visually rendering a list of alternative interpretations of the captured alternative natural phrase after the entity is textually entered.

8. The computer-implemented method of claim 7, further comprising replacing the textually entered entity with a selected one of the list of visually rendering alternative interpretations.

9. The computer-implemented method of claim 1, further comprising determining that the alternative natural phrase being assigned to the entity having arbitrary text is also assigned to a second entity having arbitrary text.

10. The computer-implemented method of claim 9, further comprising prompting the user to reassign a different alternative natural phrase to the entity.

11. The computer-implemented method of claim 9, further comprising prompting the user to reassign a different alternative natural phrase to the second entity having arbitrary text.

12. A speech recognition system that recognizes entities that have arbitrary text, the system comprising:
a speech recognition engine configured to identify an entity having arbitrary text;
an entity detection subsystem configured to detect that the entity has an identifiable pattern of characters;
a natural phrase engine configured to prompt a user to assign an alternative natural phrase that corresponds with the entity; and
a dictionary configured to store the alternative natural phrase that corresponds with the entity.

13. The speech recognition system of claim 12, wherein the natural phrase engine is further configured to suggest at least one alternative natural phrase for the entity.

14. The speech recognition system of claim 12, further comprising a speech correction subsystem configured to visually render a list of alternative interpretations of the captured alternative natural phrase after the entity is textually entered.

15. The speech recognition system of claim 12, wherein the speech recognition engine is further configured to determine that the alternative natural phrase that corresponds with the entity is also assigned to a second entity.

16. The speech recognition system of claim 15, wherein the speech recognition engine is further configured to prompt the user to reassign a different alternative natural phrase to the entity having arbitrary text.

17. The speech recognition system of claim 12, wherein the speech recognition engine is further configured to:
capture the alternative natural phrase as spoken by the user;
access the dictionary; and
textually enter the entity having arbitrary text that corresponds with the captured alternative natural phrase.

18. A computer-implemented method for entering entities that have arbitrary text using a speech recognition system, the method comprising:
capturing an alternative natural phrase as spoken by a user;
accessing a dictionary to retrieve an entity having arbitrary text that corresponds with the captured alternative natural phrase; and
textually entering the entity having arbitrary text.

19. The computer-implemented method of claim 18, further comprising visually rendering a list of alternative interpretations of the captured alternative natural phrase after the entity is textually entered.

20. The computer-implemented method of claim 19, further comprising replacing the textually entered entity having arbitrary text with a selected one of the list of visually rendered alternative interpretations.
